(19) United States
(12) Patent Application Publication
(10) Pub. No.: US 2025/0265111 A1
(43) Pub. Date: Aug. 21, 2025

(54) SYSTEMS, METHODS, AND MEDIA FOR EXECUTING A CONTAINER COMPUTING KERNEL

(71) Applicant: The Trustees of Columbia University in the City of New York, New York, NY (US)

(72) Inventors: Jason Nieh, New York, NY (US); Brett Jia, Garden City, NY (US); Kele Huang, New York, NY (US); Fanqi Yu, New York, NY (US); Xuheng Li, New York, NY (US); Ronghui Gu, New York, NY (US)

(21) Appl. No.: 19/056,667

(22) Filed: Feb. 18, 2025

Related U.S. Application Data
(60) Provisional application No. 63/553,979, filed on Feb. 15, 2024.

(51) Int. Cl. G06F 9/48; G06F 21/60; H04L 9/08

(52) U.S. Cl. CPC G06F 9/4843; G06F 21/602; H04L 9/0861

(57) ABSTRACT

Mechanisms, including systems, methods, and media, for executing a container computing kernel are provided, including: loading the container computing kernel (CCK) in a host using a hardware processor; forming a measurement of the CCK; determining whether the measurement of the CCK matches a measurement of a reference container computing kernel; and in response determining that the measurement of the CCK matches the measurement of the reference container computing kernel, running the CCK. In some embodiments, the mechanisms further include: loading the container computing kernel user service; forming a measurement of the container computing kernel user service; determining whether the measurement of the container computing kernel user service matches a measurement of a reference container computing kernel user service; and in response determining that the measurement of the container computing kernel user service matches the measurement of the reference container computing kernel user service, running the container computing kernel user service.

### CROSS-REFERENCE TO RELATED APPLICATIONS

This application claims the benefit of U.S. Provisional Patent Application No. 63/553,979, filed Feb. 15, 2024, which is hereby incorporated by reference herein in its entirety.

### BACKGROUND

Cloud computing system software, such as commodity operating system (OS) kernels and hypervisors, is increasingly complex, posing a significant security risk as large code bases contain many vulnerabilities. Attackers that successfully exploit vulnerable system software running at more privileged levels can gain unfettered access to application data and compromise data confidentiality and integrity. All major CPU architectures, including those from ARM, AMD, and INTEL, have introduced support for confidential computing environments that protect against, and are completely opaque to, privileged, untrusted system software. As virtual machines (VMs) are widely used to run applications on cloud computing infrastructure, these architectures provide confidential virtual machines (CVMs) in confidential computing environments that are protected against untrusted cloud computing system software.

Unfortunately, a key limitation of existing CVMs is that they are implemented using commodity guest operating systems which are large, complex, and vulnerable, limiting the potential security benefits of confidential computing.

Accordingly, new mechanisms for providing confidential virtual machines are desirable.

### SUMMARY

In accordance with some embodiments, mechanisms, including systems, methods, and media, for providing confidential virtual machines are provided.

In some embodiments, systems for executing a container computing kernel are provided, the systems comprising: memory; and at least one hardware processor coupled to the memory and configured to at least: load the container computing kernel in a host; form a measurement of the container computing kernel; determine whether the measurement of the container computing kernel matches a measurement of a reference container computing kernel; and in response determining that the measurement of the container computing kernel matches the measurement of the reference container computing kernel, run the container computing kernel. In some of these embodiments, the container computing kernel is loaded in a Realm world. In some of these embodiments, the measurement of the container computing kernel is a Realm Initial Measurement. In some of these embodiments, the hardware processor is further configured to: load the container computing kernel user service; form a measurement of the container computing kernel user service; determine whether the measurement of the container computing kernel user service matches a measurement of a reference container computing kernel user service; and in response determining that the measurement of the container computing kernel user service matches the measurement of the reference container computing kernel user service, run the container computing kernel user service. In some of these embodiments, the hardware processor is further configured to: decrypt an encrypted measurement of the reference container computing kernel to form the measurement of the reference container computing kernel using a key of the host. In some of these embodiments, the hardware processor is further configured to: decrypt an encrypted container key to form a container key using the key of the host; and use the container key to decrypt a manifest of a file system. In some of these embodiments, the hardware processor is further configured to: decrypt an encryption of the file system to form the file system using the container key; and authenticate the file system using the manifest.

In some embodiments, methods for executing a container computing kernel are provided, the methods comprising: loading the container computing kernel in a host using a hardware processor; forming a measurement of the container computing kernel; determining whether the measurement of the container computing kernel matches a measurement of a reference container computing kernel; and in response determining that the measurement of the container computing kernel matches the measurement of the reference container computing kernel, running the container computing kernel. In some of these embodiments, the container computing kernel is loaded in a Realm world. In some of these embodiments, the measurement of the container computing kernel is a Realm Initial Measurement. In some of these embodiments, the method further comprises: loading the container computing kernel user service; forming a measurement of the container computing kernel user service; determining whether the measurement of the container computing kernel user service matches a measurement of a reference container computing kernel user service; and in response determining that the measurement of the container computing kernel user service matches the measurement of the reference container computing kernel user service, running the container computing kernel user service. In some of these embodiments, the method further comprises: decrypting an encrypted measurement of the reference container computing kernel to form the measurement of the reference container computing kernel using a key of the host. In some of these embodiments, the method further comprises: decrypting an encrypted container key to form a container key using the key of the host; and using the container key to decrypt a manifest of a file system. In some of these embodiments, the method further comprises: decrypting an encryption of the file system to form the file system using the container key; and authenticating the file system using the manifest.

In some embodiments, non-transitory computer-readable medium containing computer executable instructions that, when executed by a processor, cause the processor to perform a method for executing a container computing kernel are provided, the method comprising: loading the container computing kernel in a host; forming a measurement of the container computing kernel; determining whether the measurement of the container computing kernel matches a measurement of a reference container computing kernel; and in response determining that the measurement of the container computing kernel matches the measurement of the reference container computing kernel, running the container computing kernel. In some of these embodiments, the container computing kernel is loaded in a Realm world. In some of these embodiments, the measurement of the container computing kernel is a Realm Initial Measurement. In some of these embodiments, the method further comprises: loading the container computing kernel user service; forming a measurement of the container computing kernel user service; determining whether the measurement of the container computing kernel user service matches a measurement of a reference container computing kernel user service; and in response determining that the measurement of the container computing kernel user service matches the measurement of the reference container computing kernel user service, running the container computing kernel user service. In some of these embodiments, the method further comprises decrypting an encrypted measurement of the reference container computing kernel to form the measurement of the reference container computing kernel using a key of the host. In some of these embodiments, the method further comprises: decrypting an encrypted container key to form a container key using the key of the host; and using the container key to decrypt a manifest of a file system. In some of these embodiments, the method further comprises: decrypting an encryption of the file system to form the file system using the container key; and authenticating the file system using the manifest.

### BRIEF DESCRIPTION OF DRAWINGS

FIG. 1 shows illustration of an example architecture for a computing container in accordance with some embodiments.

FIG. 2 shows an illustration of an example process for creating a computing container image in accordance with some embodiments.

FIG. 3 shows an illustration of an example process for deploying a computing container in accordance with some embodiments.

FIG. 4 shows an example of Realm Management Interface (RMI) ABI commands in accordance with some embodiments.

FIG. 5 shows an example of Realm Service Interface (RSI) ABI commands in accordance with some embodiments.

FIG. 6 shows an example of a container computing kernel's management interface ABI commands in accordance with some embodiments.

FIG. 7 shows an example of hardware on which the mechanisms described herein can be implemented in accordance with some embodiments.

### DETAILED DESCRIPTION

In accordance with some embodiments, mechanisms, including systems, methods, and media, for providing confidential virtual machines are provided.

In some embodiments, these mechanisms provide computing containers and software that executes as part of the containers that can be executed in confidential virtual machines.

In accordance with some embodiments, mechanisms for providing confidential virtual machines, including computing containers and software that executes as part of the containers, are described herein as being implemented in the ARM Confidential Compute Architecture (CCA). The ARM CCA provides Realms for protecting and running confidential virtual machines (CVMs) using Realm worlds, which are separate physical address spaces from Non-Secure (NS) worlds, each of which can be used for running software stacks. Within each world, instructions and privilege levels retain their existing semantics, but software in an NS world cannot access CPU state and memory used by software in a Realm world.

While the mechanisms described herein are described for illustration purposes in the context of ARM CCA, it should be understood that these mechanisms can additionally or alternatively be implemented in any other suitable confidential computing architectures such as AMD SEV-SNP and INTEL TDX, in some embodiments.

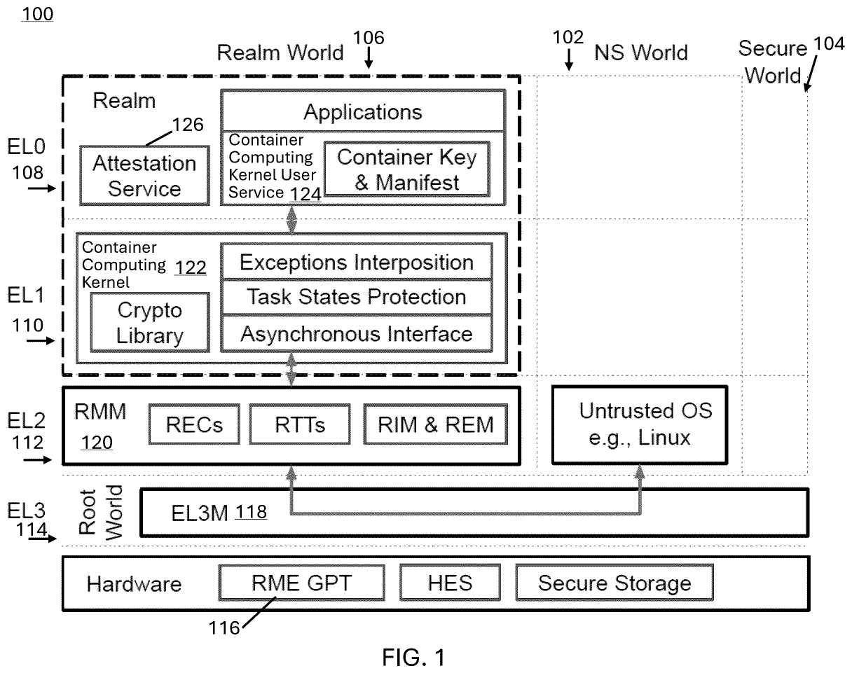

Turning to FIG. 1, an overview of an ARM CCA in which a computing container in accordance with some embodiments can be implemented is illustrated. As shown, in this ARM CCA, its Realm Management Extension (RME) provides: NS world(s) 102, which can be used by many software stacks; Secure world(s) 104, which can be used to host platform security services; and Realm world(s) 106 which can be fully compatible with NS world so that software stacks that run in NS world can also run in Realm world. As also shown, in this ARM CCA, its RME also provides three privilege levels in each world: EL0 108 for user applications, EL1 110 for kernel(s), and EL2 112 for hypervisor(s). EL2 can also be used for running host OS kernels with integrated hypervisors, such as Linux, when Virtualization Host Extensions are enabled, in some embodiments. Because Realm worlds 106 and NS worlds 102 are mutually distrusting, RME provides a fourth Root world EL3 114 at the highest privilege level to manage switching between the other worlds, in some embodiments.

In some embodiments, each NS world 102, each Secure world 104, and each Realm world 106 have their own Physical Address Space (PAS). In some embodiments, each 4 KB (or any other suitable size) frame of physical memory, which can be referred to as a granule, belongs to one PAS at any given time. Granules can be dynamically transitioned from NS PAS to Realm PAS, in some embodiments. In some embodiments, there is no static partitioning of resources between NS and Realm worlds. In some embodiments, RME hardware checks each memory access against a Granule Protection Table (GPT) 116 that tracks the PAS of each granule and enforces that NS world can only access its own memory while Realm world and Secure world can access their own respective memory and NS memory, but cannot access each other's memory. In some embodiments, RME hardware requires all Direct Memory Access (DMA) accesses to be subject to GPT checks, protecting the Realm PAS against DMA-based attacks.

In some embodiments, the Arm CCA relies on two trusted firmware components: EL3 Monitor (EL3M) 118 and RMM 120. EL3M runs in Root world to context switch CPU execution among the three other worlds and manage the GPT, in some embodiments. In some embodiments, only EL3M can access memory in any PAS and change the PAS of a granule, which involves updating its entry in the GPT. Software running in a Realm world or a Secure world can issue a Secure Monitor Call (SMC) to EL3M to request a PAS change, in some embodiments. For example, only an SMC from a Realm world can change a granule's PAS between an NS world and a Realm world, in some embodiments.

In some embodiments, RMM is a small trusted computing base (TCB) that runs at EL2 in each Realm world to control the execution of Realms, isolate Realms from each other, and enforce Realm security guarantees. It manages Realm Translation Tables (RTTs), the page tables for each Realm, such that each granule is only mapped to one Realm's RTTs and therefore only accessible to one Realm, in some embodiments. It also provides attestation measurements of the contents of a Realm, in some embodiments. Untrusted system software running in NS world can be used to handle other more complex functionality, in some embodiments. For example, to run Realm CVMs, RMM protects the confidentiality and integrity of CVMs while relying on existing hypervisors for everything else, including resource allocation and scheduling, physical hardware support, and device emulation, in some embodiments.

In some embodiments, the computing containers described herein leverage Arm CCA to protect the computing containers in Realm world with a commodity OS running in NS world. This is accomplished by extending RMM and populating a Realm with additional services, in some embodiments. The RMM extension supports multiple address spaces per Realm and provides a more optimized path for interactions between NS world and RMM when mediated by a Realm, in some embodiments.

In some embodiments, a Realm used for running a computing container (as described herein) loads and runs a container computing kernel 122 with a minimal TCB. In some embodiments, this container computing kernel securely interfaces with a commodity OS to provide commodity OS services to applications, but unlike CVMs, without needing to run the commodity OS as part of the TCB inside a Realm. In some embodiments, each Realm runs its own instance of the container computing kernel 122 at exception level EL1. In some embodiments, the container computing kernel can then interpose on all system calls, exceptions, and interrupts for the Realm, while being fully contained in a Realm to benefit from its security guarantees.

In some embodiments, container computing kernel 122 loads and runs a container computing kernel user service 124, which acts in part as a specialized loader that ensures only trusted binaries can run in a Realm container. The container computing kernel user service also launches an attestation service 126 that allows remote users to connect and obtain the RMM's attestation measurement to ensure the Realm container is loaded with the contents the user is expecting and can thus be trusted, in some embodiments.

In some embodiments, although the computing containers described herein leverage new architecture capabilities to provide strong security guarantees, these computing containers can be built and deployed in the same way as standard containers. In some embodiments, the computing containers do not rely on any changes to the container runtime stack to execute. In some embodiments, the computing containers can be built with and used by any Open Container Initiative (OCI)-compliant containerization tool, such as DOCKER, available from Docker, Inc. of Palo Alto, CA, and/or PODMAN, available from Red Hat, of Raleigh, NC.

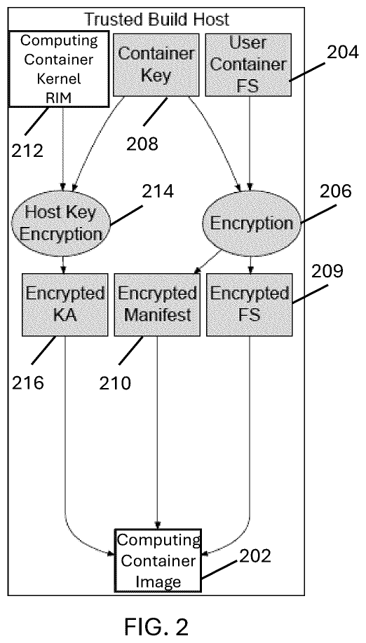

In accordance with some embodiments, FIG. 2 shows an example of a process for forming a computing container image 202. As illustrated, a user container file system 204 undergoes a post-processing step which encrypts at 206 each file block in the container file system in a size-preserving manner using a unique container key 208 to produce an encrypted file system 209. Any suitable size-preserving encryption technique and any suitable unique container key can be used in some embodiments. This can be done transparently to the user as part of the computing container build pipeline, in some embodiments. In some embodiments, authentication tags and nonces for each block can stored in a container manifest, which can be used for validation. In some embodiments, the container manifest can be encrypted at 206 using container key 208 or any other suitable container key to produce an encrypted container manifest 210. Container key 208 along with a measurement of a container computing kernel 212 from a trusted provider are encrypted at 214 using the public key of the host on which it will run to produce an encrypted Key Authentication (KA) data structure 216, in some embodiments. Encrypted file system 209, encrypted manifest 210, and encrypted KA data structure 216 can then be combined to form computing container image 202.

In some embodiments, the KA data structure can only be decrypted in a Realm running a trusted instance of the container computing kernel, at which point it can be used by the container computing kernel. In some embodiments, only the container computing kernel can decrypt the container contents, so encryption protects the confidentiality of files and the manifest from the OS. In some embodiments, the container computing kernel can use the manifest's authentication tags to validate decrypted files, protecting their integrity from the OS.

In some embodiments, computing containers as described herein use attestation and encryption to provide a chain of trust from RMM through the container computing kernel and the container computing kernel user service all the way to the container image and its file system. In some embodiments, a user can determine whether or not a Realm is trusted. If the Realm is trusted, the Realm will protect data confidentiality and integrity, in some embodiments. If the Realm is not trusted, the Realm cannot violate data confidentiality and integrity if the user chooses not to use it, in some embodiments.

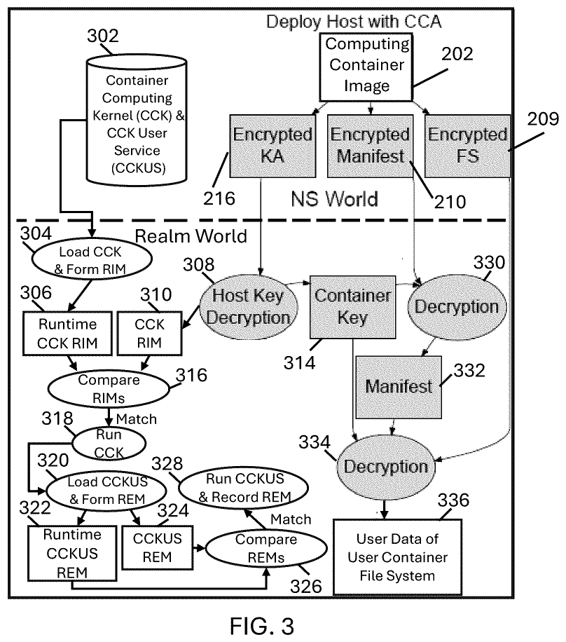

Turning to FIG. 3, an example of a process for deploying a computing container in accordance with some embodiments is illustrated. As shown, at 304, an OS starts a computing container in Realm world by loading it with a container computing kernel from storage 302 and the RMM records an immutable Realm Initial Measurement (RIM) 306 of the Realm with the container computing kernel, in some embodiments. In some embodiments, HES uses the host's private key to decrypt encrypted KA data structure 216 to produce container computing kernel RIM 310 and a container key 314, which are based on container computing kernel RIM 212 and a container key 208 of FIG. 2. The RIM 306 is compared to RIM 310 at 316, in some embodiments. If RIMs 306 and 310 match, the container computing kernel starts running at 318, in some embodiments.

In some embodiments, once the container computing kernel starts running in the computing container, at 320, the container computing kernel user service is loaded and the container computing kernel computes a Realm Extensible Measurement (REM) 322 of the container computing kernel user service and compares it at 326 to a built-in REM 324 of the container computing kernel user service. The container computing kernel refuses to run the container computing kernel user service if the REMs do not match, in some embodiments. If the measurements do match, at 328, the container computing kernel runs the container computing kernel user service and the RMM records the REM, in some embodiments.

In some embodiments, the container computing kernel user service next reads container key 314 and the encrypted manifest 210. In some embodiments, the container computing kernel next decrypts the encrypted manifest 210 using the container key 314 at 330 to produce unencrypted manifest 332.

RMM records a REM for the container key and manifest, in some embodiments. In some embodiments, a remote user can then request the Realm's attestation measurement, including the RIM and the REMs for the container computing kernel, the container computing kernel user service, the manifest, and the key, so that the user can validate that all software loaded in the container and the container image used by the container match what is expected and can thus be trusted.

In some embodiments, the container computing kernel user service can then load encrypted file system 209 in the container, and the container computing kernel can transparently decrypt the encrypted file system and authenticate the decrypted file system 336 against manifest 332.

In some embodiments, the computing containers described herein can run just like a normal DOCKER container, which are generally ephemeral and disposable, except that the data confidentiality and integrity of the computing containers described herein are protected from the OS and other untrusted software. In some embodiments, the container computing kernel ensures that only the container computing kernel user service and authenticated encrypted binaries can be executed in the computing container, and only authenticated encrypted files from the container image can be accessed in the computer container, protecting configuration files and other container image file data from the OS and other untrusted software. Persistent data storage generated by applications is the responsibility of applications to protect, such as through cryptographic means, in some embodiments.

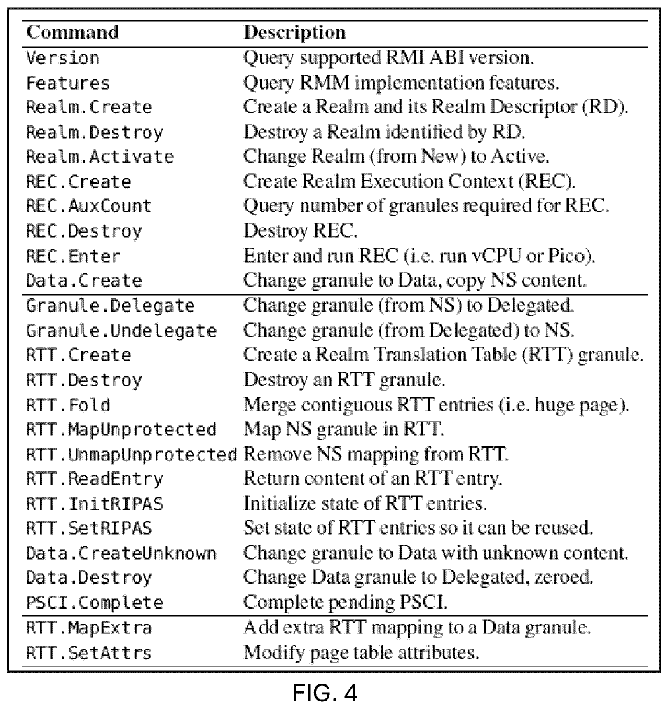

In some embodiments, RMM is extended to enable Realms to support the computing containers described herein while preserving existing support for CVMs. The extended RMM provides a Realm Management Interface (RMI) ABI shown in the table of FIG. 4 that can be used by untrusted system software, such as an OS or hypervisor. RMI commands listed from Granule.Delegate and below, including RTT.MapExtra and RTT.SetAttrs, are also exported to be called from within Realms (eRMI commands) to support confidential containers as discussed further below.

In some embodiments, a delegation mechanism enables system software running in NS world to retain its ability to manage memory, including reclaiming memory assigned to a Realm, without having access to Realm state. NS world software delegates memory to Realm world using Granule.Delegate, and undelegates memory back to NS world using Granule.Undelegate, in some embodiments. In some embodiments, delegated memory must be mapped with the RMIs Data.Create or Data.CreateUnknown to be usable by the Realm. In some embodiments, RMM does not itself manage its own pool of memory for Realms, so there are no arbitrary limits on the number of Realms on a system, which is only limited by the amount of physical memory available. In some embodiments, RMM always zeros a granule when it is delegated to Realm world to reduce the risk of accidental information flow when a granule is reused or undelegated.

In some embodiments, a Realm is created using Realm.Create, with a flag to indicate that it is used for a container. Realm Execution Contexts (RECs) are created for a Realm to manage its register contexts, analogous to vCPUs in VMs, in some embodiments. For example, as many RECs as there are CPUs are created so that the container computing kernel can use all available CPUs to run, in some embodiments. In some embodiments, RTTs are created inside Realm world and therefore are protected from system software in NS world. RMM ensures that an RTT is configured in accordance with the Realm's Protected Address Range (PAR), which identifies a fixed region of address space at Realm creation that can only be mapped with delegated granules, in some embodiments. In some embodiments, an initial program (e.g., the container computing kernel) can be copied from NS world into the Realm's PAR via Data.Create. In some embodiments, Realm creation concludes with Realm.Activate, where a Realm Initial Measurement (RIM) is generated for later attestation. After that, no more RECs can be created and only zeroed memory can be mapped to the Realm's PAR using Data.CreateUnknown, in some embodiments. In some embodiments, Data.Create can no longer be used so that the OS cannot map NS content in a Realm's PAR after it is activated. To provide flexibility for Realms to access NS memory, NS memory can be mapped outside the PAR at any time, in some embodiments. The container computing kernel leverages this to pass system call parameters between a Realm container and the OS, in some embodiments.

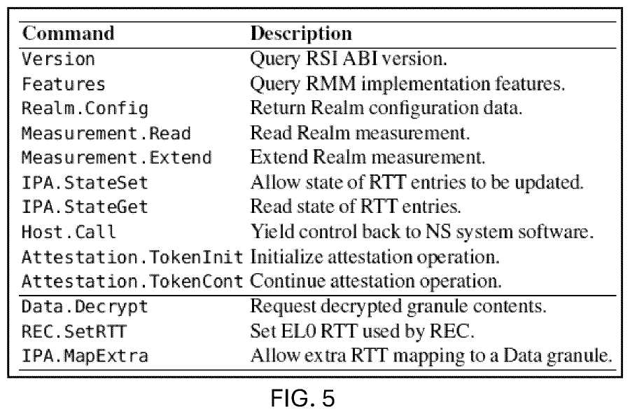

In some embodiments, RMM provides a Realm Service Interface (RSI) ABI shown in the table of FIG. 5 between Realms and RMM, primarily to enable Realms to perform attestation and allow existing RTT entries to be reused. A Realm can use RSIs to read and extend Realm measurements, as well as generate signed measurement tokens to be used for remote attestation, in some embodiments. To guarantee Realm integrity, RMM embeds a Realm IPA State (RIPAS) in each RTT entry recording whether it is in use, in some embodiments. In some embodiments, Data.CreateUnknown and Data.Destroy RMI commands will only succeed if the respective RIPAS is in the corresponding state. In some embodiments, a Realm adjusts the RIPAS for an RTT entry by issuing an IPA.StateSet RSI command, and untrusted system software can acknowledge by issuing a RTT.SetRIPAS RMI command.

In some embodiments, RMM is extended to repurpose RTTs as ARM Stage 1 page tables for Realm containers. RTTs can then translate directly from virtual addresses to physical addresses, in some embodiments. All RTT.*, Data.*, and IPA.* commands issued for a Realm container will perform operations on Stage 1 page tables instead of Stage 2 page tables, in some embodiments. In some embodiments, RMM ensures that RMI commands can only map a delegated Realm granule to a Realm's RTT inside its PAR, and cannot map a Realm granule that is already mapped to a Realm's RTT to another Realm's RTT. As a result, confidentiality and integrity guarantees are preserved as the relevant RMI commands provide the exact same functionality except using Stage 1 instead of Stage 2 page tables, in some embodiments. In some embodiments, an RTT.SetAttrs command can be provided to allow an OS to request RMM to set page table entry attributes to support commodity OS functionality. In some embodiments, RTT.SetAttrs does not change any actual mappings, so it does not affect Realm confidentiality and integrity.

In some embodiments, RMM is extended to support multiple address spaces per Realm, including Arm's separate user (EL0) and kernel (EL1) address spaces. In some embodiments, RMM is extended to support multiple RTTs per Realm, where each RTT is created using RTT.Create. Specifically, in some embodiments, the first RTT created before Realm activation is used as the EL1 kernel page table for the container computing kernel while subsequent RTTs can be used as EL0 page tables. In some embodiments, Data.* and RTT.* commands can identify the address space to which they should be applied by specifying the respective address of the base RTT granule. In some embodiments, a REC.SetRTT RSI command can be used to allow a Realm to change the RTT used for EL0 execution when running a REC. REC.SetRTT can only be used to switch to RTTs of the issuing Realm so that inter-Realm confidentiality and integrity guarantees are preserved.

To enable multiple processes in a Realm to map the same granule, in some embodiments, RMM is extended to allow a granule that is already mapped to an RTT to be mapped to another RTT in the same Realm if the Realm explicitly provides permission to do so. In some embodiments, RMM will allow a granule to only be mapped to a single RTT by default. Specifically, in some embodiments, an IPA.MapExtra RSI command can be used to allow an OS to issue a RTT.MapExtra RMI command to map an already mapped granule to another RTT in the same Realm. In some embodiments, this does not affect Realm confidentiality and integrity since an already mapped granule cannot be mapped to another Realm and cannot be mapped to the same Realm without explicit Realm permission. In some embodiments, RTT.MapExtra restricts the duplicate mappings that it provides to read-only mappings, or read-write mappings at the same virtual address as an existing RTT entry.

In some embodiments, RMM is extended to support issuing the eRMI commands in the table of FIG. 3 directly by the Realm as RSI commands. When an untrusted OS directly issues RMI commands, it necessitates a world switch between an NS world and a Realm world, which is costly. In some embodiments, Realms are allowed to directly issue eRMI commands as RSI commands to avoid this performance cost. In some embodiments, as discussed below, the container computing kernel can use this capability to allow the OS to issue multiple RMI commands together without incurring a world switch on each command. In some embodiments, exporting RMI commands to the RSI does not break Realm integrity or confidentiality guarantees with respect to attacks from the NS world because RSI calls can only be initiated from within a Realm. In some embodiments, RMM identifies the Realm issuing an RSI call, and the effects of the call will only be applied to the issuing Realm. In some embodiments, RMI commands in the table of FIG. 3 are not exported to Realms because they are only used before a Realm is activated or when the Realm is terminated.

In some embodiments, the container computing kernel has a minimal trusted computing base (TCB) because it only needs to provide a basic execution environment and secure confidential data passed between a Realm and the OS, and relies on a commodity OS to provide standard system call functionality.

In some embodiments, the container computing kernel supports dynamic creation of processes and threads in Realms using existing system calls such as fork and clone, and transparently encrypts and decrypts all Realm protected data passed to and from the OS without any modifications to containerized applications. This includes supporting encrypted container images and execution of encrypted binaries with the container computing kernel user service binary loader to protect file system state. In some embodiments, attestation and encryption are combined to provide a chain of trust from RMM through the container computing kernel and the container computing kernel user service to the container image.

In some embodiments, the container computing kernel provides five main functions: supporting a task abstraction for processes and threads; translating system calls to any necessary RSI commands to provide explicit Realm permission for RTT operations; making system call parameters available to the OS to provide system call functionality; cryptographically securing any confidential data that is passed between the Realm and the OS; and optimizing performance by minimizing transitions to and from the OS in NS world.

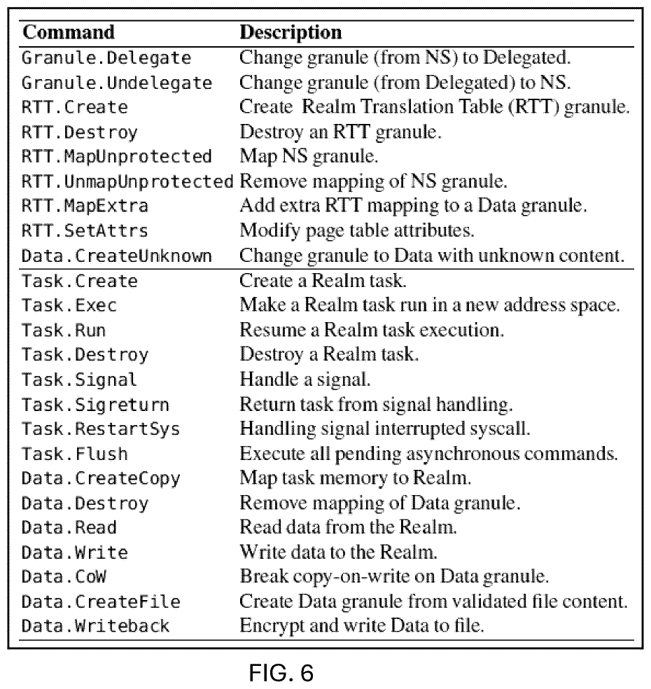

In some embodiments, the container computing kernel provides a management interface ABI shown in the table of FIG. 6 for an OS to request the container computing kernel to dynamically create, destroy, and run tasks by multiplexing them onto RECs.

In some embodiments, a Task.Create command uses a delegated granule as the task state granule for a new task, either the initial task in a container or as a result of a fork or clone system call by an application.

In some embodiments, a Task.Exec command uses an existing task to run a new program by overwriting its task state granule as a result of an exec system call by an application.

In some embodiments, an OS can schedule a task to run by calling a Task.Run command, which causes the container computing kernel to restore the task context from its task state granule, set its RTT for use by the underlying REC via REC.SetRTT, and perform an exception return to run the task.

In some embodiments, the container computing kernel can issue IPA.StateSet RSI commands to an RMM to provide explicit permission to reuse portions of the Realm's PAR only in accordance with memory-related system calls, ensuring that the OS cannot change any part of the Realm's PAR that is already in use without Realm permission.

In some embodiments, the container computing kernel can issue IPA.MapExtra RSI commands to the RMM to provide explicit permission to map an already-used Data granule to another RTT entry to support fork system calls and copy-on-write (COW) optimization. In some embodiments, the container computing kernel issues RSI commands as needed in response to exceptions generated by the Realm, such as page faults.

In some embodiments, to pass system call parameters between a Realm and the OS in NS world, the container computing kernel interposes on system calls to copy their parameters between a Realm's PAR and NS memory buffers mapped to the Realm outside the PAR, which can then be accessed by the OS. Consider copying system call buffers to the OS: in some embodiments, the container computing kernel checks that buffers are already faulted in, in which case it proactively copies parameters to temporary NS buffers before transitioning to the OS, which will in turn copy the parameters from the temporary NS buffers to NS kernel space. In some embodiments, if the buffers are not faulted in, the container computing kernel logs the addresses and sizes of buffers used as system call parameters before transitioning to the OS, which will in turn issue Data.Read calls to request the container computing kernel to copy the respective buffer directly into the OS-specified buffer in NS kernel space. In some embodiments, the container computing kernel checks the addresses and sizes to confirm that they are the ones used as system call parameters before reactively copying the buffers to NS kernel space. Proactive copying avoids an extra world switch and can be used whenever possible since it less costly, even with an extra copy to a temporary NS buffer, in some embodiments. In some embodiments, copying system call buffers back to the Realm is handled similarly using temporary NS buffers. In some embodiments, the container computing kernel tracks virtual address space allocations to ensure that virtual addresses for new memory allocations do not overlap existing mappings to protect against memory-based Iago attacks. In some embodiments, the container computing kernel checks that return values for system calls are within expected ranges.

In some embodiments, when copying system call parameters between a Realm and the OS, the container computing kernel needs to ensure that any confidential data is not disclosed, such as when using interprocess communication (IPC) to communicate between processes in a Realm container. In some embodiments, the container computing kernel accomplishes this by transparently encrypting any confidential data passed into system calls, including IPC-related and file-related system calls.

In some embodiments, the container computing kernel uses an encrypted container file system. In some embodiments, the encryption mechanism only operates on file contents, making it compatible with any existing file system. Specifically, in some embodiments, when a container image is created, each 4 KB block of each file in the image is encrypted with an authenticated cipher, such as ChaCha20-Poly1305 or any other suitable cipher, in a size-preserving manner and the resulting authentication tag and per-block unique nonce are stored separately in a per-container manifest. In some embodiments, this data is stored separately in the manifest since the file block may already be full of file data and have no additional room to store the authentication tag and nonce. In some embodiments, once all files are encrypted and their tags and nonces stored in the manifest, the manifest is encrypted by the container key and added to the container image, generating its own manifest authentication tag and nonce. The container key, manifest authentication tag, and manifest nonce are then encapsulated in a Key Authentication (KA) data structure together with a signed RIM for the version of the container computing kernel that must be used by the container, and that KA structure and signed RIM is encrypted using the public key of the host on which the container will run, in some embodiments.

In some embodiments, the KA data structure is delivered to the container computing kernel which will issue a Data.Decrypt RSI command with the granule containing the KA to request RMM to use Hardware Enforced Security (HES) to return the decrypted container key, manifest authentication tag, and manifest nonce to the container computing kernel. In some embodiments, RMM will only return the decrypted contents if the RIM is signed by a trusted container computing kernel provider, such as a software manufacturer or cloud provider, and the signed RIM matches the RIM computed by RMM when the Realm was activated. A corrupted container computing kernel instance will not be able to obtain the container key to decrypt any files in the container image, in some embodiments. In some embodiments, the decrypted information is kept safe by storing it in the Realm's PAR.

In some embodiments, when file-related system calls, as well as memory-mapped operations on files, are used to access files in the container file system, the container computing kernel will transparently decrypt and encrypt file blocks as needed. In some embodiments, for read operations, the container computing kernel requests granules of file data from the untrusted OS and decrypts the granule with its container key and the nonce in the manifest, validating the result with the authentication tag in the manifest. In some embodiments, for write operations, the container computing kernel writes and re-encrypts the updated granules, updates the in-memory contain manifest with the new authentication tags and nonces, and returns the encrypted granules to the OS. In some embodiments, nonces can be generated in any suitable manner, such as by using a 96-bit (or any other suitable size) binary counter initialized to be greater than the highest-valued nonce in the manifest, ensuring that nonces are unique.

In some embodiments, for memory-mapped files, the OS uses Data.Destroy when invalidating page table entries as part of munmap and fsync, which re-encrypts the granule and undelegates it back to the OS to complete the write.

In some embodiments, in all memory-mapped file operations, when a granule is re-encrypted for the OS to write back to disk, the in-memory container manifest is updated with the new authentication tag and nonce. In some embodiments, if the OS returns file system information that the container computing kernel is unable to authenticate against the container manifest, the container computing kernel will cause the Realm and container to exit. This preserves the integrity guarantee that an EL0 application will not observe any changes to the container file system that it did not make, in some embodiments.

In some embodiments, the container manifest can be used to allow a computing container to use unencrypted file content outside the container image. In some embodiments, the manifest can be used to whitelist files or directories that the container computing kernel should not decrypt or encrypt to provide access to other file systems mounted in the computing container, including external storage mounts (e.g., such as KUBERNETES persistent volumes) to store persistent user data. In some embodiments, special file systems such as /dev and /proc can also be whitelisted, with the caveat that such data is not authenticated and could provide a vector for Iago attacks.

In accordance with some embodiments, the mechanisms described herein provide the ability for an operating system to issue multiple commands and defer their execution to some later time when the OS returns execution to the Realm. In other words, in some embodiments, multiple commands can be batched and asynchronously executed later when a world switch occurs. In some embodiments, many such commands result in a corresponding eRMI command being issued as an RSI command, effectively amortizing the cost of a world switch over multiple RMI commands.

In some embodiments, the container computing kernel defines two types of commands: asynchronous; and synchronous. Asynchronous commands are commands that can be batched and their execution deferred until some later world switch when execution returns to the container computing kernel in the Realm. Synchronous commands are commands that cannot be deferred and must be executed synchronously with an immediate world switch back to the container computing kernel, which completes the command and returns execution back to the OS. In some embodiments, commands are per Realm.

In some embodiments, an OS maintains one or more FIFO command queues and one or more sequence numbers that can be used to control the execution ordering of deferred commands. When the OS issues a command, the command is assigned a current sequence number which is incremented for asynchronous commands. If the command is asynchronous, it is added to the command queue, in some embodiments. If the command is synchronous, it causes a world switch back to Realm to run the container computing kernel, which then processes all outstanding asynchronous commands with a lower sequence number before processing the synchronous command, in some embodiments.

In some embodiments, there are six synchronous kernel commands: Task.Flush; Task.Run; Data.Read; Data.Write; Data.Writeback; and Granule.Undelegate.

In some embodiments, the OS calls a Task.Flush command to world switch back to the container computing kernel and have the container computing kernel process any outstanding commands before the Task.Flush command before returning to the OS. In some embodiments, all other synchronous kernel commands also first process any outstanding kernel commands then perform some additional functionality defined by the synchronous command.

In some embodiments, the OS schedules a Realm task to run by calling a Task.Run command to resume a task execution in the Realm world. This causes a world switch back to the container computing kernel, which then runs the respective task and does not return execution back to the OS until a system call, exception, or interrupt occurs, in some embodiments.

In some embodiments, the OS issues a Data.Read command when it needs to copy data from a user space buffer that is an input parameter for a system call and the buffer has not been faulted in. This must be synchronous because the OS may immediately need that data when the copy returns to continue executing the system call, in some embodiments.

In some embodiments, the OS issues a Data.Write command when it needs to copy data to a user space buffer that is an output parameter for a system call and the buffer has not been faulted in. This is synchronous because the copy may cause an error if the buffer is invalid, in some embodiments. The OS needs to know the result of the copy immediately when it returns because the error may cause the OS to produce a different result for the system call, such as a different return value, in some embodiments.

In some embodiments, the OS issues a Data.Writeback command to request encrypted data back from the container computing kernel in 4 KB (or any other suitable size), page-aligned blocks to complete a write system call.

In some embodiments, the OS issues a Granule.Undelegate command when it reclaims delegated but otherwise unused memory from Realm world. The OS needs to have the granule undelegated synchronously since it may immediately repurpose the granule for something else, in some embodiments.

In some embodiments, a container computing kernel user service provides user-level services and interoperates with the container computing kernel to provide certain security guarantees for Realm containers.

In some embodiments, unlike the container file system, the container computing kernel user service is unencrypted so that the OS can execute it.

In some embodiments, an OS loads the container computing kernel user service into the Realm by first loading it into NS memory just like any other program, then issuing kernel commands to transfer the container computing kernel user service from NS memory into the Realm. Specifically, in some embodiments, the OS delegates memory to the Realm, requests the container computing kernel to create an RTT for the address space of the container computing kernel user service using an RTT.Create command, and requests the container computing kernel to map delegated granules to the RTT and copy NS memory to those granules using a Data.CreateCopy command. In some embodiments, the OS issues a Task.Create command to create the task metadata for the container computing kernel user service to run as the first task, which will also link the task granule with the created RTT. At this point, the container computing kernel user service has been fully loaded into the Realm, including copying its file-backed memory content into the Realm, in some embodiments. In some embodiments, the container computing kernel will compute an REM of the container computing kernel user service and compare it to its own built-in measurement the container computing kernel user service. If it matches, the container computing kernel will request RMM to record the REM, otherwise it will refuse to run the container computing kernel user service, in some embodiments. The REM presumes that the entire binary of the container computing kernel user service has been pre-faulted in and copied into the Realm, in some embodiments. Failure to do so will result in an REM that is inconsistent with the container computing kernel's built-in measurement so that it does not run, in some embodiments. Once started, the container computing kernel user service loads a file containing the KA data structure at a well-known address in its address space so it can be accessed by the container computing kernel, in some embodiments. If the container computing kernel successfully obtains from RMM the decrypted container key, manifest authentication tag, and manifest nonce, it requests RMM to record an REM for them, in some embodiments. In some embodiments, the authentication tag and nonce are unique to the manifest, and the manifest is unique to the container image, so a measurement of the key, manifest authentication tag, and manifest nonce is sufficient for a user to determine if the contents of the container image that will be used in the Realm can be trusted. In a similar fashion, in some embodiments, the container computing kernel user service loads the file containing the encrypted container manifest at another well-known address so that it can be accessed by the container computing kernel, which the container computing kernel can decrypt using the container key and validate using the manifest authentication tag.

In some embodiments, the container computing kernel user service provides a userspace ELF interpreter so that it can load ELF binaries into its own address space and execute them. Because all binaries are encrypted, the OS cannot use its own ELF loader to load and execute program since their encrypted format will not be understood by the kernel's ELF loader, in some embodiments. Instead, the container computing kernel user service is responsible for loading encrypted binaries from within the Realm, which it can do because the container computing kernel will interpose on all file-related system calls and transparently decrypt the binaries so the container computing kernel user service can work with the decrypted versions of the binaries, in some embodiments. Furthermore, in some embodiments, before the decrypted binaries are provided to the container computing kernel user service, the container computing kernel will validate each decrypted file block against its authentication tag in the container manifest to ensure the block containing executable content can be trusted. Any block that fails the container computing kernel's authentication check will be rejected by the container computing kernel, ensuring that the container computing kernel user service will only load trusted executable content, in some embodiments. The container computing kernel user service does not need to fault in all the pages of a program all at once since each page will be decrypted and validated by the container computing kernel as it is faulted in, in some embodiments. Once the container computing kernel user service loads a program, it simply jumps to the first instruction of the program and starts executing, in some embodiments.

In some embodiments, the container computing kernel user service is initially run as the pid 1 process in the computing container. When run initially, it launches both the attestation service and the entrypoint program for the container, in some embodiments. The container computing kernel user service forks a second process (pid 2), which simply loads and executes an encrypted binary from the container image that provides an attestation service, in some embodiments. In some embodiments, this attestation service can be integrated with a suitable attestation library, such as OpenEnclave, to provide a protocol for remote users to connect to and get a Realm attestation token. In some embodiments, the Realm attestation token is signed by RMM so it cannot be forged, allowing a user to verify that the attestation measurement came from RMM and is for the specific Realm. In some embodiments, the token includes the RIM and REMs for the Realm, including measurements of the container computing kernel, the container computing kernel user service, and the manifest, so that the user can validate all the software loaded in the Realm container is as expected and can be trusted before deciding to use the Realm container. The attestation service remains running for the lifetime of the container, in some embodiments. In some embodiments, after forking the attestation service, the initial process of the container computing kernel user service loads the container entry point program into its own address space and begins executing the program's first instruction.

Aside from this initialization of the EL0 Realm, the container computing kernel user service is also responsible for serving as the ELF interpreter of all subsequent tasks running in the container, in some embodiments. In some embodiments, when it is not executed as the first process in the Realm container, the container computing kernel user service only performs its ELF interpreter functions. In this context, it will be executed as a result of a container task calling exec on some program, in some embodiments, which will cause the OS to exec the container computing kernel user service with its arguments, including the program and the program's arguments, so that this instance of the container computing kernel user service can load and run the program, in some embodiments. The container computing kernel requires that subsequent executable of the container computing kernel user service that is loaded as a result of exec is the exact same executable that was used for the first process in the Realm container, in some embodiments. In particular, in some embodiments, the container computing kernel will compute an REM for the subsequent executable of the container computing kernel user service and check that it matches the REM for the initial binary of the container computing kernel user service used for the first process to confirm that no new unencrypted binary is loaded into the Realm container. Since the initial binary of the container computing kernel user service is already part of the attestation, this ensures that the subsequent binary of the container computing kernel user service that is loaded matches user expectation and can be trusted, in some embodiments. For variable parts of the container computing kernel user service's address space, e.g. arguments and environment variables, the container computing kernel performs additional validation based on the exec context, in some embodiments. This ensures that even though the container computing kernel user service is stored in plaintext, any use of it by the OS is authenticated by the container computing kernel, in some embodiments. Other than the container computing kernel user service, in some embodiments, all other binaries that run in the Realm container must be loaded by the container computing kernel user service and decrypted and validated by the container computing kernel against the container manifest.

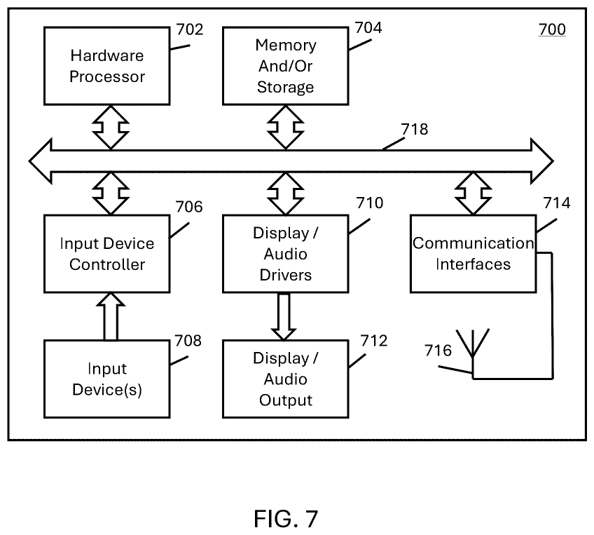

In accordance with some embodiments, the mechanisms described herein can be implemented on any suitable general-purpose computer or special-purpose computer. Any such general-purpose computer or special-purpose computer can include any suitable hardware. For example, as illustrated in example hardware 700 of FIG. 7, such hardware can include hardware processor 702, memory and/or storage 704, an input device controller 706, an input device 708, display/audio drivers 710, display and audio output circuitry 712, communication interface(s) 714, an antenna 716, and a bus 718.

Hardware processor 702 can include any suitable hardware processor, such as a microprocessor, a micro-controller, digital signal processor(s), dedicated logic, and/or any other suitable circuitry for controlling the functioning of a general-purpose computer or a special purpose computer in some embodiments. For example, in some embodiments, hardware processor 702 can be implemented using an ARM Armv9-A processor available from ARM Inc. of Cambridge, United Kingdom, or a processor compatible therewith

Memory and/or storage 704 can be any suitable memory and/or storage for storing programs, data, and/or any other suitable information in some embodiments. For example, memory and/or storage 704 can include random access memory, read-only memory, flash memory, hard disk storage, optical media, and/or any other suitable memory.

Input device controller 706 can be any suitable circuitry for controlling and receiving input from input device(s) 708 in some embodiments. For example, input device controller 706 can be circuitry for receiving input from an input device 708, such as a touch screen, from one or more buttons, from a voice recognition circuit, from a microphone, from a camera, from an optical sensor, from an accelerometer, from a temperature sensor, from a near field sensor, and/or any other type of input device.

Display/audio drivers 710 can be any suitable circuitry for controlling and driving output to one or more display/audio output circuitries 712 in some embodiments. For example, display/audio drivers 710 can be circuitry for driving one or more display/audio output circuitries 712, such as an LCD display, a speaker, an LED, or any other type of output device.

Communication interface(s) 714 can be any suitable circuitry for interfacing with one or more communication networks. For example, interface(s) 714 can include network interface card circuitry, wireless communication circuitry, and/or any other suitable type of communication network circuitry.

Antenna 716 can be any suitable one or more antennas for wirelessly communicating with a communication network in some embodiments. In some embodiments, antenna 716 can be omitted when not needed.

Bus 718 can be any suitable mechanism for communicating between two or more components 702, 704, 706, 710, and 714 in some embodiments.

Any other suitable components can additionally or alternatively be included in hardware 700 in accordance with some embodiments.

It should be understood that at least some of the above-described functions of the processes of FIGS. 2 and 3 can be executed or performed in any order or sequence not limited to the order and sequence shown in and described in the figures. Also, some of the above functions of these processes can be executed or performed substantially simultaneously where appropriate or in parallel to reduce latency and processing times. Additionally or alternatively, some of the above described functions of these processes can be omitted.

In some embodiments, any suitable computer readable media can be used for storing instructions for performing the functions and/or processes described herein. For example, in some embodiments, computer readable media can be transitory or non-transitory. For example, non-transitory computer readable media can include media such as non-transitory magnetic media (such as hard disks, floppy disks, and/or any other suitable magnetic media), non-transitory optical media (such as compact discs, digital video discs, Blu-ray discs, and/or any other suitable optical media), non-transitory semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A system for executing a container computing kernel, comprising:
memory; and
at least one hardware processor coupled to the memory and configured to at least:
load the container computing kernel in a host;
form a measurement of the container computing kernel;
determine whether the measurement of the container computing kernel matches a measurement of a reference container computing kernel;
in response determining that the measurement of the container computing kernel matches the measurement of the reference container computing kernel, run the container computing kernel.

2. The system of claim 1, wherein the container computing kernel is loaded in a Realm world.

3. The system of claim 1, wherein the measurement of the container computing kernel is a Realm Initial Measurement.

4. The system of claim 1, wherein the hardware processor is further configured to:
load the container computing kernel user service;
form a measurement of the container computing kernel user service;
determine whether the measurement of the container computing kernel user service matches a measurement of a reference container computing kernel user service;
in response determining that the measurement of the container computing kernel user service matches the measurement of the reference container computing kernel user service, run the container computing kernel user service.

5. The system of claim 1, wherein the hardware processor is further configured to: decrypt an encrypted measurement of the reference container computing kernel to form the measurement of the reference container computing kernel using a key of the host.

6. The system of claim 5, wherein the hardware processor is further configured to:
decrypt an encrypted container key to form a container key using the key of the host; and
use the container key to decrypt a manifest of a file system.

7. The system of claim 6, wherein the hardware processor is further configured to:
decrypt an encryption of the file system to form the file system using the container key; and
authenticate the file system using the manifest.

8. A method for executing a container computing kernel, comprising:
loading the container computing kernel in a host using a hardware processor;
forming a measurement of the container computing kernel;
determining whether the measurement of the container computing kernel matches a measurement of a reference container computing kernel;
in response determining that the measurement of the container computing kernel matches the measurement of the reference container computing kernel, running the container computing kernel.

9. The method of claim 8, wherein the container computing kernel is loaded in a Realm world.

10. The method of claim 8, wherein the measurement of the container computing kernel is a Realm Initial Measurement.

11. The method of claim 8, further comprising:
loading the container computing kernel user service;
forming a measurement of the container computing kernel user service;
determining whether the measurement of the container computing kernel user service matches a measurement of a reference container computing kernel user service;
in response determining that the measurement of the container computing kernel user service matches the measurement of the reference container computing kernel user service, running the container computing kernel user service.

12. The method of claim 8, further comprising decrypting an encrypted measurement of the reference container computing kernel to form the measurement of the reference container computing kernel using a key of the host.

13. The method of claim 12, further comprising:
decrypting an encrypted container key to form a container key using the key of the host; and
using the container key to decrypt a manifest of a file system.

14. The method of claim 13, further comprising:
decrypting an encryption of the file system to form the file system using the container key; and
authenticating the file system using the manifest.

15. A non-transitory computer-readable medium containing computer executable instructions that, when executed by a processor, cause the processor to perform a method for executing a container computing kernel, the method comprising:
loading the container computing kernel in a host;
forming a measurement of the container computing kernel;
determining whether the measurement of the container computing kernel matches a measurement of a reference container computing kernel;
in response determining that the measurement of the container computing kernel matches the measurement of the reference container computing kernel, running the container computing kernel.

16. The non-transitory computer-readable medium of claim 15, wherein the container computing kernel is loaded in a Realm world.

17. The non-transitory computer-readable medium of claim 15, wherein the measurement of the container computing kernel is a Realm Initial Measurement.

18. The non-transitory computer-readable medium of claim 15, wherein the method further comprises:
loading the container computing kernel user service;
forming a measurement of the container computing kernel user service;
determining whether the measurement of the container computing kernel user service matches a measurement of a reference container computing kernel user service;
in response determining that the measurement of the container computing kernel user service matches the measurement of the reference container computing kernel user service, running the container computing kernel user service.

19. The non-transitory computer-readable medium of claim 15, wherein the method further comprises decrypting an encrypted measurement of the reference container computing kernel to form the measurement of the reference container computing kernel using a key of the host.

20. The non-transitory computer-readable medium of claim 19, wherein the method further comprises:
decrypting an encrypted container key to form a container key using the key of the host; and
using the container key to decrypt a manifest of a file system.

21. The non-transitory computer-readable medium of claim 20, wherein the method further comprises:
decrypting an encryption of the file system to form the file system using the container key; and
authenticating the file system using the manifest.
